(19) United States
(12) Patent Application Publication
(10) Pub. No.: US 2026/0118473 A1
(43) Pub. Date: Apr. 30, 2026

(54) REFERENCE SIGNAL CONFIGURATION FOR INTERFERENCE MITIGATION

(71) Applicant: QUALCOMM Incorporated, San Diego, CA (US)

(72) Inventors: Stelios STEFANATOS, San Diego, CA (US); Kapil GULATI, Belle Mead, NJ (US); Junyi LI, Greentown, PA (US); Preeti KUMARI, San Diego, CA (US)

(21) Appl. No.: 18/841,526

(22) PCT Filed: Mar. 8, 2023
(86) PCT No.: PCT/US2023/063985

§ 371 Date: Aug. 26, 2024

(30) Foreign Application Priority Data
Apr. 4, 2022 (GR) 20220100294

(51) Int. Cl. G01S 7/02; G01S 7/282; G01S 7/292; G01S 13/26; H04J 13/00

(52) U.S. Cl. CPC G01S 7/0232; G01S 7/0234; G01S 7/282; G01S 7/2927; G01S 13/26; H04J 13/0029

(57) ABSTRACT

Various aspects of the present disclosure generally relate to wireless communication. In some aspects, a network node may transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The network node may receive a response for the set of radar reference signals. Numerous other aspects are described.

### CROSS-REFERENCE TO RELATED APPLICATION

This patent application claims priority to Greek Patent Application No. 20220100294, filed on Apr. 4, 2022, entitled “REFERENCE SIGNAL CONFIGURATION FOR INTERFERENCE MITIGATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for reference signal configuration for interference mitigation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The method may include receiving a response for the set of radar reference signals.

Some aspects described herein relate to a network node for wireless communication. The network node may include a memory and one or more processors coupled to the memory. The one or more processors may be configured to transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The one or more processors may be configured to receive a response for the set of radar reference signals.

Some aspects described herein relate to a non-transitory computer-readable medium that stores a set of instructions for wireless communication by a network node. The set of instructions, when executed by one or more processors of the network node, may cause the network node to transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The set of instructions, when executed by one or more processors of the network node, may cause the network node to receive a response for the set of radar reference signals.

Some aspects described herein relate to an apparatus for wireless communication. The apparatus may include means for transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The apparatus may include means for receiving a response for the set of radar reference signals.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of interference in joint communications and radar sensing (JCR) systems, in accordance with the present disclosure.

FIGS. 5A-5C are diagrams illustrating examples associated with reference signal configuration for interference mitigation, in accordance with the present disclosure.

FIG. 6 is a diagram illustrating an example process associated with reference signal configuration for interference mitigation, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

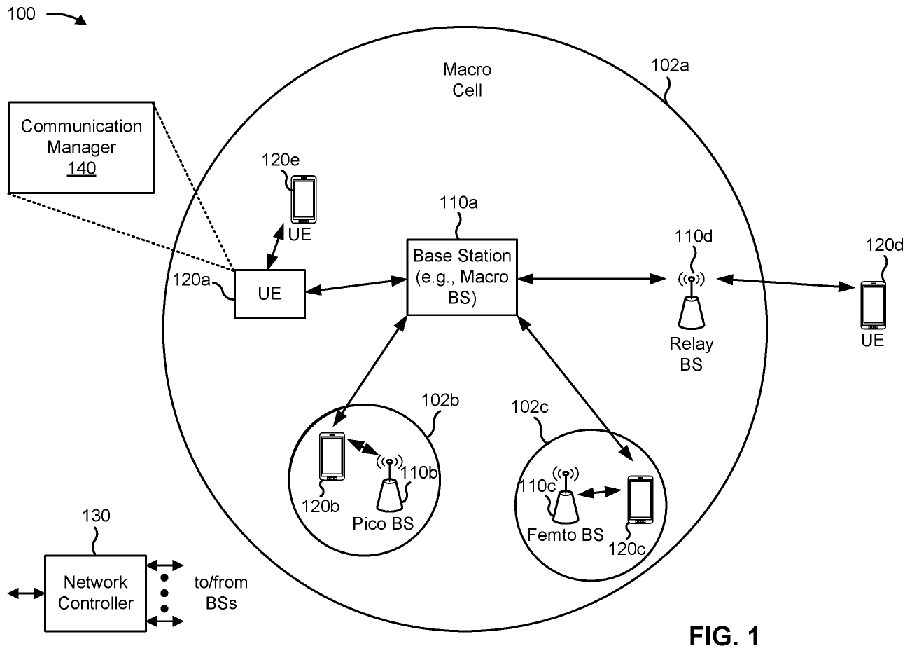

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node, such as the UE 120, may include a communication manager 140. As described in more detail elsewhere herein, the communication manager 140 may transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and receive a response for the set of radar reference signals. Additionally, or alternatively, the communication manager 140 may perform one or more other operations described herein.

As indicated above, FIG. 1 is provided as an example. Other examples may differ from what is described with regard to FIG. 1.

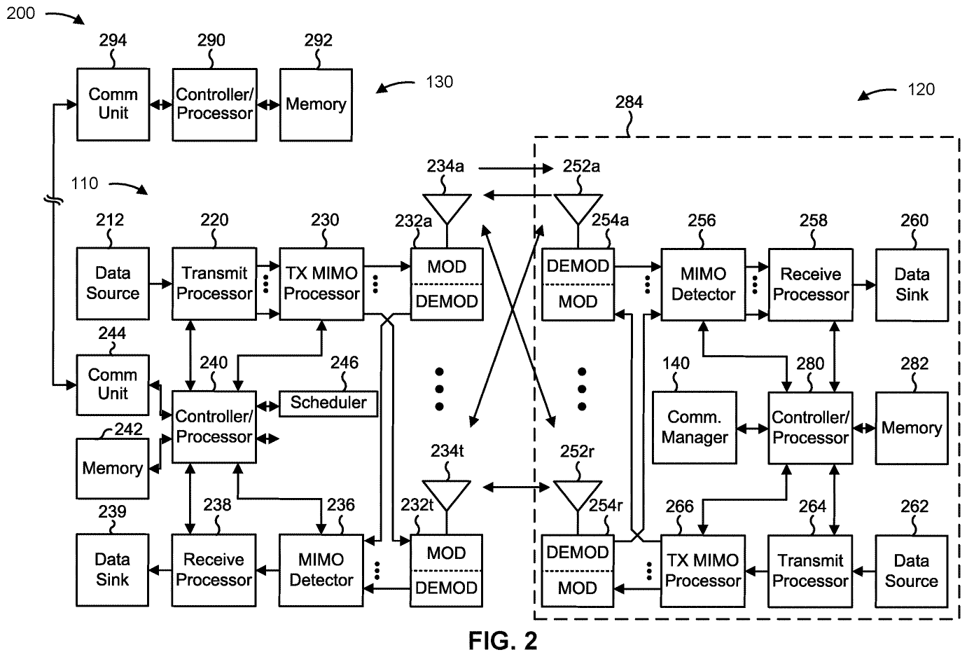

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna army may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

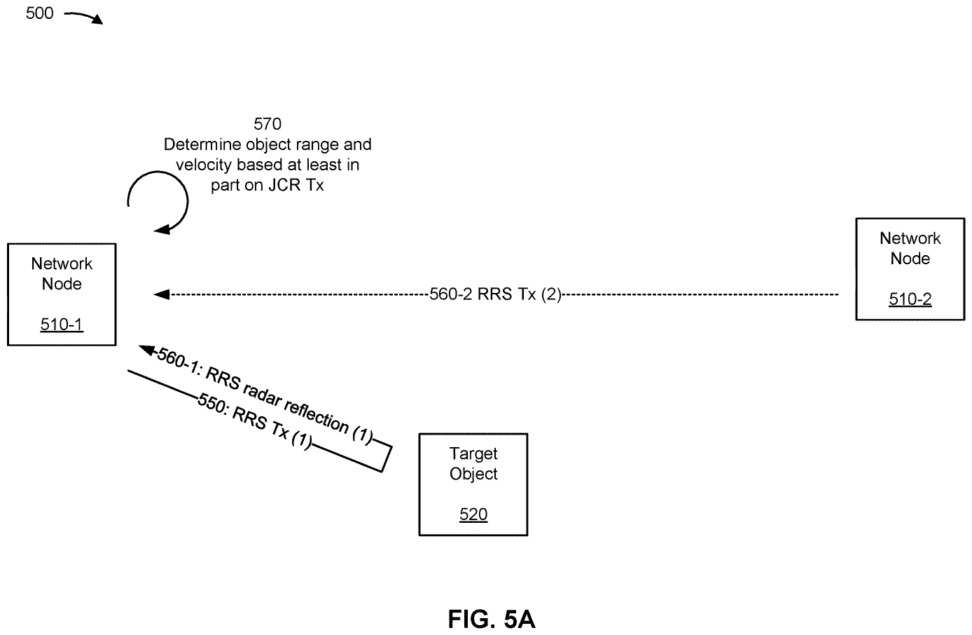

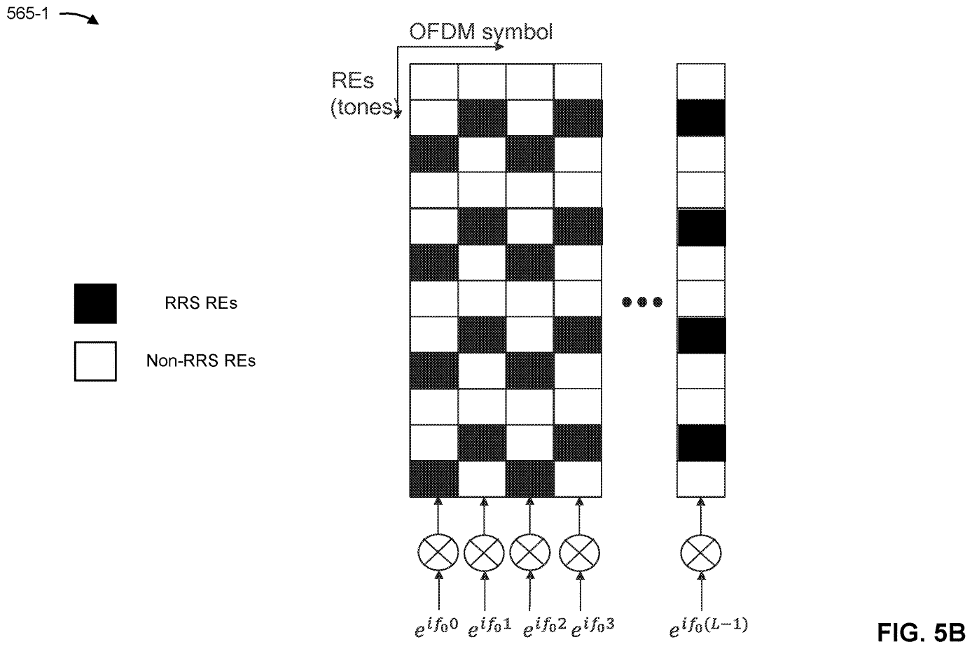

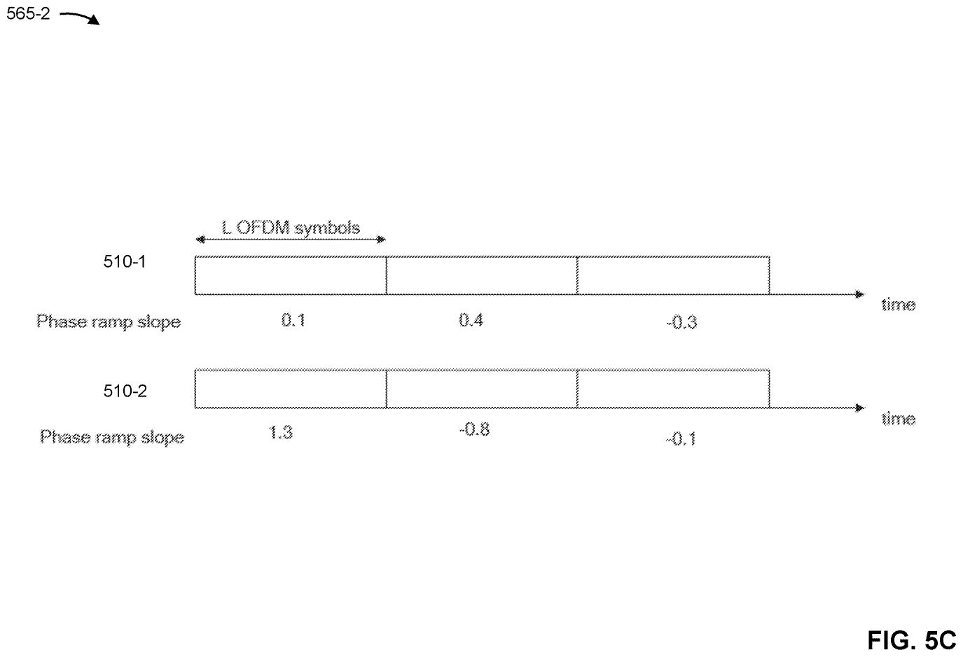

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-7).

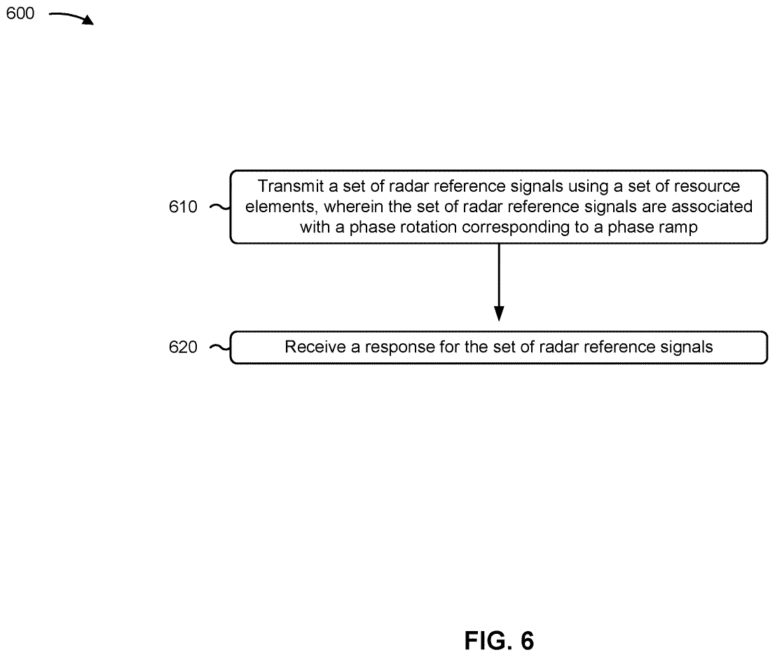

The controller/processor 240 of the base station 110, the controller/processor 280 of the UE 120, and/or any other component(s) of FIG. 2 may perform one or more techniques associated with reference signal configuration for interference mitigation, as described in more detail elsewhere herein. In some aspects, the network node described herein is the UE 120, is included in the UE 120, or includes one or more components of the UE 120 shown in FIG. 1. For example, the controller/processor 240 of the base station 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, a network node, such as the UE 120, includes means for transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and/or means for receiving a response for the set of radar reference signals. In some aspects, the means for the network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

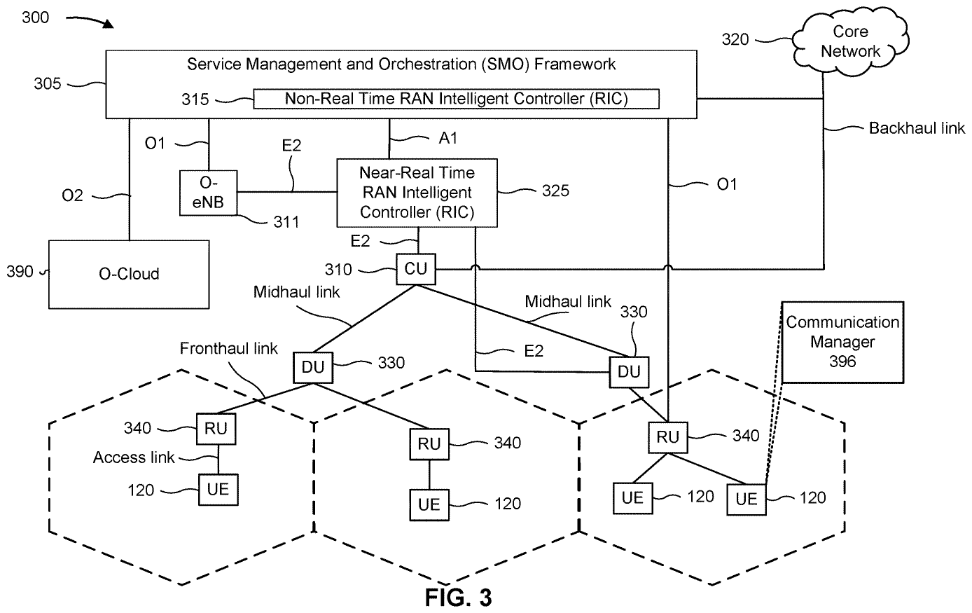

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120, which may include respective communication managers 396 (e.g., corresponding to communication manager 140), via one or more radio frequency (RF) access links. One or more network nodes or network entities described herein may correspond to the UE 120 and/or may include the communication manager 396. Communication manager 396 may be a component of another network node, such as an RU 340, a DU 330, or a CU 310, among other examples. The UE 120 may be simultaneously served by multiple RUs 340.

Each of the units (e.g., the CUs 310, the DUs 330, the RUs 340), as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), or service data adaptation protocol (SDAP), among other examples. Each control function can be implemented with an interface configured to communicate signals with other control functions hosted by the CU 310. The CU 310 may be configured to handle user plane functionality (Central Unit—User Plane (CU-UP)), control plane functionality (Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an open RAN (O-RAN) configuration. The CU 310 can be implemented to communicate with the DU 330, as necessary, for network control and signaling.

The DU 330 may correspond to a logical unit that includes one or more base station functions to control the operation of one or more RUs 340. The DU 330 may host one or more of a radio link control (RLC) layer, a medium access control (MAC) layer, and one or more high physical (PHY) layers (such as modules for forward error correction (FEC) encoding and decoding, scrambling, or modulation and demodulation, among other examples) depending, at least in part, on a functional split, such as those defined by the 3GPP. The DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, or physical random access channel (PRACH) extraction and filtering, among other examples), or both, based at least in part on the functional split, such as a lower layer functional split. In such an architecture, the RU(s) 340 can be implemented to handle over the air (OTA) communication with one or more UEs 120. Real-time (RT) and non-real-time (non-RT) aspects of control and user plane communication with the RU(s) 340 can be controlled by the corresponding DU 330. This configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., an O1 interface). For virtualized network elements, the SMO Framework 305 may be configured to interact with a cloud computing platform (e.g., an open cloud (O-Cloud) 390) to perform network element life cycle management (e.g., to instantiate virtualized network elements) via a cloud computing platform interface (e.g., an O2 interface). Such virtualized network elements can include, but are not limited to, CUs 310, DUs 330, RUs 340 and Near-RT RICs 325. The SMO Framework 305 can communicate with a hardware aspect of a 4G RAN, such as an open eNB (O-eNB) 311, via an O1 interface. Additionally, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., via an A1 interface) the Near-RT RIC 325. The Near-RT RIC 325 may be configured to include a logical function that enables near-real-time control and optimization of RAN elements and resources via data collection and actions over an interface (e.g., via an E2 interface) connecting one or more CUs 310, one or more DUs 330, or both, as well as an O-eNB, with the Near-RT RIC 325.

To generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., reconfiguration via O1) or via creation of RAN management policies (e.g., A1 policies).

As indicated above, FIG. 3 is provided as an example. Other examples may differ from what is described with respect to FIG. 3.

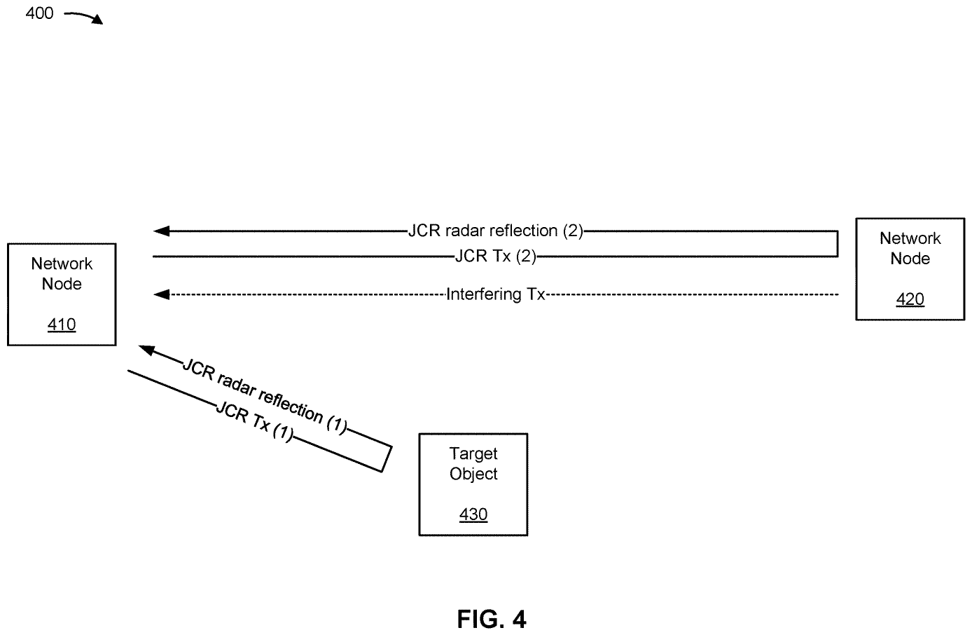

FIG. 4 is a diagram illustrating an example 400 of interference in joint communications and radar sensing (JCR) systems, in accordance with the present disclosure.

A network node, such as network node 410, may use radio frequency (RF) sensing (e.g., radar sensing) for environmental sensing (e.g., to detect targets). For example, in automotive deployments (e.g., V2V communications systems, V2X communications systems, V2P communications systems, or V2I communications systems, among other examples), a network node associated with a vehicle may transmit one or more radar transmissions and measure one or more radar reflections (e.g., reflections of the radar transmission off of a target) to determine a distance of a target, a speed of the target, a direction of the target, or an acceleration of the target, among other examples. Reserving dedicated RF resources for radar sensing may result in an inefficient use of RF resources. For example, in cases where few network nodes are performing RF sensing, some RF resources may go unused while communication resources are congested with transmissions from many network nodes.

Accordingly, some communications systems may integrate wireless communications with RF sensing using a single waveform or transmission. In this case, rather than having a first set of RF resources dedicated for radar sensing and a second set of resources dedicated for communication, a single set of resources is allocated for both communication and radar sensing. For example, some techniques may use a 3GPP (e.g., NR) waveform for both communication and radar sensing, thereby enabling 3GPP devices (e.g., UEs, base stations, CUs, DUs, RUs, network nodes, or network entities, among other examples) to provide radar sensing using receive processors, such as receive processor 258 of FIG. 2. A configuration in which both communication and radar sensing is enabled for a single set of resources (and using a single waveform) may be termed a “joint communication and radar sensing” or “joint communication and radar” (“JCR”) deployment.

As shown in FIG. 4, a network node 410 transmits a set of JCR transmissions toward another network node 420 and a target object 430 and attempts to measure a set of JCR radar reflections (e.g., reflections of the JCR transmissions of the network node 420 and the target object 430). At the network node 410, a radar cyclic prefix (CP) orthogonal frequency division multiplexing (OFDM) (CP-OFDM) receiver extracts information regarding a range and velocity of network node 420 and the target object 430 by performing channel estimation on the set of JCR radar reflections. Network node 410 (e.g., the receiver of the JCR radar reflections) determines a channel impulse response (CIR) based on one or more pilot resource elements (pilot tones) and/or one or more data resource elements (data tones). Network node 410 may determine the CIR for an m-th OFDM symbol as:

$${h}_{m} ( τ ) = {b}_{0} {e}^{i 2 π {f}_{d} Tm} δ ( τ - {τ}_{0} )$$

where τ is a delay variable, m is an OFDM symbol index, b₀ is a complex amplitude of a CIR peak (e.g., a CIR peak corresponding to a target), τ₀ is a delay of a CIR peak (e.g., the CIR peak corresponding to the target), T is a duration of an OFDM symbol, and f_{d} is a Doppler shift of the CIR peak (e.g., corresponding to movement of the target).

Based at least in part on the channel estimation, network node 410 determines a strongest energy peak of the CIR and a propagation delay associated with the strongest energy peaks. The propagation delay corresponds to a range of a target (e.g., network node 420 or the target object 430) and a Doppler shift corresponds to a velocity of the target. Network node 410 may determine the Doppler shift from a linear change to the phase of an OFDM symbol (e.g., a phase ramp). Network node 410 may determine a direction of movement based on beamforming or angle of arrival (AoA) determination (e.g., using multiple antennas). For example, network node 410 may detect a target (e.g., network node 420 or the target object 430) by coherently combining CIR determinations for a set of M OFDM symbols of a coherent processing interval (CPI). Delay-Doppler processing within a CPI interval enables association of an energy M|b₀|² corresponding to a delay-Doppler pair (τ₀, f_{d}). In this case, when the energy satisfies a threshold (e.g., is greater than a threshold amount), network node 410 may determine that a target with a corresponding range and velocity is detected.

As further shown in FIG. 4, when network node 410 is receiving the set of JCR radar reflections, network node 410 may also receive an interfering transmission. For example, network node 420 may transmit on the same resources that network node 410 is using for radar sensing. In some deployments, network node 410 may implement interference-avoidance channel-access mechanisms to avoid such interference.

As indicated above, FIG. 4 is provided as an example. Other examples may differ from what is described with respect to FIG. 4.

As described above, channel-access mechanisms may be deployed for sidelink UEs, non-cooperating base stations, or other network nodes, among other examples. For example, a first network node (and one or more second network nodes) may use listen-before-talk mechanisms and/or channel reservation mechanisms to avoid the one or more second network nodes transmitting using the same resources as the first network node uses for JCR-based target detection. However, channel-access mechanisms may not achieve a threshold level of reliability (in terms of interference-avoidance) to enable JCR-based target detection. In other words, interference may result in target detection failures, which may include detecting targets that are not present (termed “phantom targets” or “ghost targets”) or determining an incorrect range and/or velocity. Although channel-access mechanisms reduce interference-related target detection failures, a rate of interference-related target detection failure may still be higher than a threshold required for reliability for some use cases, such as for autonomous vehicle navigation or factory automation.

Some aspects described herein provide improved robustness and reliability for JCR-based target detection. For example, a set of network nodes may have a configured radar reference signal with a phase ramp to use for JCR-based target detection. In this case, the radar reference signal is configured with the phase ramp to enable interference mitigation at a network node that is performing JCR-based target detection. In other words, even when two network nodes transmit JCR transmissions using the same resources, each network node can identify the interference from the other network node and cancel the interference based at least in part on the respective phase ramps applied to the respective JCR transmissions. In this way, a likelihood of interference-related target detection failures is eliminated or reduced to less than a threshold associated with high reliability use cases.

FIGS. 5A-5C are diagrams illustrating an example 500 of reference signal configuration for interference mitigation, in accordance with the present disclosure. As shown in FIG. 5A, a network node 510-1, a network node 510-2, and a target object 520 may be within a communication range of each other.

As shown by reference numbers 550, 560-1, and 560-2, network node 510-1 may transmit a set of radar reference signals (RRSs) and may receive a set of RRS responses (which may also be termed “radar returns”). For example, network node 510-1 may transmit a first radar reference signal toward target object 520 and may receive a response to the first radar reference signal (e.g., a reflection of the first radar reference signal off target object 520). In this case, network node 510-1 may receive a second radar reference signal transmitted by network node 510-2 (e.g., using the same resources as was used for the first radar reference signal).

In some aspects, network nodes 510 may transmit the respective radar reference signal for JCR-based target detection. For example, when network nodes 510 are attempting to sense target object 520, network nodes 510 may transmit respective radar reference signals. Alternatively, network node 510-2 may transmit the radar reference signal when network node 510-2 is not performing JCR-based target detection. For example, network node 510-2 may transmit a set of resource elements (e.g., tones) associated with the radar reference signal even when network node 510-2 is not performing JCR-based target detection to enable network node 510-1 to perform interference cancelling, as described below.

In some aspects, each network node 510 may be configured with the same resource element pattern for the radar reference signals. For example, a network node 510 may determine the resource element pattern based at least in part on a static configuration, a received configuration, or a stored configuration, among other examples, that is common to each network node 510. In this case, by using the same resource element pattern, each network node 510 is aware of the transmission configuration of each other network node 510, thereby enabling interference cancelling using phase rotation identification, as described below. In other words, using a common resource element pattern prevents network node 510-1 from experiencing a noise floor increase that would mask target detection as can occur when using a random or pseudo-random resource element pattern.

In some aspects, network node 510-1 may generate a radar reference signal (e.g., a symbol or value of a radar reference signal resource element) based at least in part on a base and a phase rotation. The base may be a complex-valued symbol that is common to each network node 510. For example, both network node 510-1 and network node 510-2 may use the same base for generating the radar reference signal in the same resource element. Additionally, or alternatively, the base may differ across different resource elements. For example, network nodes 510 may use a first base for a first resource element and a second base for a second resource element. In some aspects, the base may be a sequence for a set of radar reference signal symbols. For example, the base may be a base symbol sequence based at least in part on a Gold sequence mapped to quadrature phase shift keying (QPSK) symbols. In this case, a duration of the base symbol sequence may be one or more OFDM symbols. The base symbol sequence may be repeated to cover all OFDM symbols of a JCR transmission if the base sequence is not as long as a radar transmission duration. Similarly, the resource element pattern, as described above, may span one or more OFDM symbols and may repeat to cover all OFDM symbols of a JCR transmission.

The phase rotation may differ across each network node 510 and/or for each OFDM symbol transmitted by a single network node 510. For example, network node 510-1 may use a first phase rotation for a first resource element (e.g., for all radar reference signals within a first OFDM symbol) and a second phase rotation for a second resource element (e.g., within a second OFDM symbol), and network node 510-2 may use a third phase rotation for the first resource element and a fourth phase rotation for the second resource element. In some aspects, the phase rotation may change across OFDM symbols to achieve a phase ramp. For example, network node 510-1 may select a first phase rotation for a first OFDM symbol, a second phase rotation for a second OFDM symbol, and a third phase rotation for a third OFDM symbol such that a phase ramp occurs with respect to the first OFDM symbol, the second OFDM symbol, and the third OFDM symbol. In some aspects, network node 510-1 may differentiate the phase ramp from other network nodes 510. For example, network node 510-1 may select a phase ramp slope using a random or pseudo-random procedure that enables each network node 510 to select a different phase ramp slope. In this case, when network node 510-1 is determining a CIR, determined velocities resulting from radar reference signals of network node 510-1 will appear to shift proportional to the phase ramp. The difference between phase ramp rates can be selected independently by different network nodes 510, which man enable identification of radar reference signals associated with objects and radar reference signals associated with other network nodes 510 that are also transmitting.

In some aspects, network nodes 510 may use a particular duration for the phase ramp. For example, network node 510-1 may select a phase ramp duration less than or equal to a CPI for the radar reference signals (e.g., which may be an integer number of OFDM symbols). In some aspects, the CPI may be pre-configured for each network node 510 (e.g., with or without a corresponding phase ramp duration). In some aspects, each network node 510 may be configured to select the same phase ramp duration. Additionally, or alternatively, network node 510-1 may select the phase ramp duration based at least in part on a configuration of network node 510-1 (e.g., such that network node 510-1 and network node 510-2 may select different phase ramp durations). In some aspects, network node 510-1 may select the phase ramp from a range of values. For example, network node 510-1 may be configured with a minimum phase ramp duration and a maximum phase ramp duration from which network node 510-1 may select the phase ramp duration. Similarly, network node 510-1 may select a phase ramp slope for changing the phase ramp across time intervals, such as based at least in part on a stored configuration, a range of configured value, or a pattern (e.g., selected from a codebook of phase ramp slope patterns), among other examples.

In this case, in generating OFDM symbols, network node 510-1 applies phase rotations to radar reference signals, but not to data resource elements. By applying the phase rotations to the radar reference signals, network nodes 510 enable differentiation of superimposed (e.g., interfering) radar reference signals from different network nodes 510 (e.g., thereby avoiding detection of phantom targets).

In some aspects, a network node 510 may transmit information indicating a configuration of a radar reference signal. For example, network node 510-1 may transmit information indicating the phase ramp that is applied to the first radar reference signal to network node 510-2. In this case, network node 510-2 can use the first radar reference signal as a channel estimation reference signal (e.g., for a communication link) in addition to the first radar reference signal being used by network node 510-1 for JCR-based target detection. In this case, based at least in part on the radar reference signal resource element pattern and base being common to each network node 510, network node 510-1 may only indicate the phase ramp that is applied to the first radar reference signal to enable network node 510-2 to use the first radar reference signal for channel estimation. In some aspects, network node 510-1 or another coordinating entity may transmit an indication to enable network node 510-2 to derive the phase ramp. For example, when phase ramps are selected from a codebook or look-up table, network node 510-1 or another coordinating entity may transmit an indication of an index value, of the codebook, corresponding to the phase ramp (e.g., in sidelink control information (SCI) types 1 (SCI1) or 2 (SCI2), in downlink control information (DCI), in uplink control information (UCI), or in radio resource control (RRC) signaling, among other examples). In this case, network node 510-2 may use the index value to determine the phase ramp from the codebook and may monitor for the first radar reference signal to perform channel estimation.

As shown in FIG. 5B, diagram 565-1 shows an example of a comb radar reference signal pattern spanning two OFDM symbols (with repetition). In this case, the resource element pattern has a periodicity that is an even number of OFDM symbols, resulting in the resource element pattern resetting across each slot. As shown, a phase rotation of f₀m is applied to each radar reference signal resource element of an m-th OFDM symbol (m=0 to L−1, as shown for a slot of length L=14). In this case, a single phase ramp is applied to L consecutive OFDM symbols of a slot. In other words, a first slot may have a first phase ramp for L consecutive OFDM symbols and a second slot may have a second phase ramp for L consecutive OFDM symbols of a slot. Further to the example, as shown in FIG. 5C and by diagram 565-2, network node 510-1 uses a first pattern of phase ramp slopes (e.g., 0.1 for a first set of L OFDM symbols, 0.4 for a second set of L OFDM symbols, and −0.3 for a third set of L OFDM symbols). In contrast, network node 510-2 uses a second pattern of phase ramp slopes (e.g., 1.3 for the first set of L OFDM symbols, −0.8 for the second set of L OFDM symbols, and −0.1 for the third set of L OFDM symbols). In some aspects, an OFDM symbol of a slot may be configured without any radar reference signals. For example, to reserve resources for communications, some OFDM symbols may omit radar reference signals. In this case, network node 510-1 may forgo applying a phase rotation to any resource elements within an OFDM symbol that lacks a radar reference signal resource element.

Returning to FIG. 5A, and as shown by reference number 570, network node 510-1 may perform JCR-based target detection. For example, network node 510-1 may determine a target range and/or velocity using received radar reference signal responses (e.g., the first radar reference signal and/or the second radar reference signal). In this case, when a phase ramp difference between radar reference signals changes within a CPI, a phantom target associated with the second radar reference signal will appear as having a velocity that varies within the CPJ. As a result, a CIR peak associated with the phantom target will have a smaller energy than, for example, CIR peaks associated with “true” targets (e.g., target object 520 detected based at least in part on the first reference signal). In this case, network node 510-1 may filter the CIR peak associated with the phantom target at a constant false alarm rate (CFAR) detection stage of a radar algorithm. In contrast, when the phase ramp difference between the radar reference signal is fixed within the CPI (but changes among CPIs), the CIR peak associated with the phantom target will have a threshold energy level, which may prevent CFAR detection stage filtering. However, network node 510-1 will, in this case, detect that the velocity of the phantom target changes discontinuously (and randomly or pseudo-randomly) across CPIs rather than continuously as occurs with velocities associated with true targets. In some aspects, the discontinuous velocity changes may include changes of velocity of more than a threshold amount between two measurements. In some aspects, the discontinuous velocity changes may include changes of velocity of more than a threshold amount across a threshold quantity of measurements (e.g., two or more measurements). Accordingly, network node 510-1 may apply a tracking filter to a set of CPIs to identify the discontinuous velocity changes and remove detections associated with discontinuous velocity changes as phantom targets.

As an example, network node 510-1 may determine a CIR based at least in part on the first radar reference signal and the second radar reference signal as:

$$h [ m , n ] = {b}_{0} {e}^{i 2 π {f}_{d} Tm} δ ( τ - {τ}_{0} ) + {b}_{i} {e}^{i 2 π {f}_{d , i} Tm + i Δ ( m ) m} δ ( τ - {τ}_{i} )$$

where f_{d,i} represents a Doppler shift from a phantom target, Δ(m) represents a phase ramp slope difference between the first radar reference signal and the second radar reference signal, τᵢ represents range of the phantom target (resulting from a presence of interference by the second radar reference signal). Within a CPI, a delay-Doppler pair of target object 520 is detected with the same energy, whereas an energy of the phantom target changes across different Doppler values f_{d,i}+Δ(m)/2πT (with one or more Doppler values detected if the phase ramp difference changes during the CPI). In this case, a CIR peak can be dropped at the CFAR detection stage or as a result of discontinuous velocity changes.

As indicated above, FIGS. 5A-5C are provided as examples. Other examples may differ from what is described with respect to FIGS. 5A-5C.

FIG. 6 is a diagram illustrating an example process 600 performed, for example, by a network node, in accordance with the present disclosure. Example process 600 is an example where the network node (e.g., base station 110, UE 120, CU 310, DU 330, RU 340, or network nodes 510, among other examples) performs operations associated with reference signal configuration for interference mitigation.

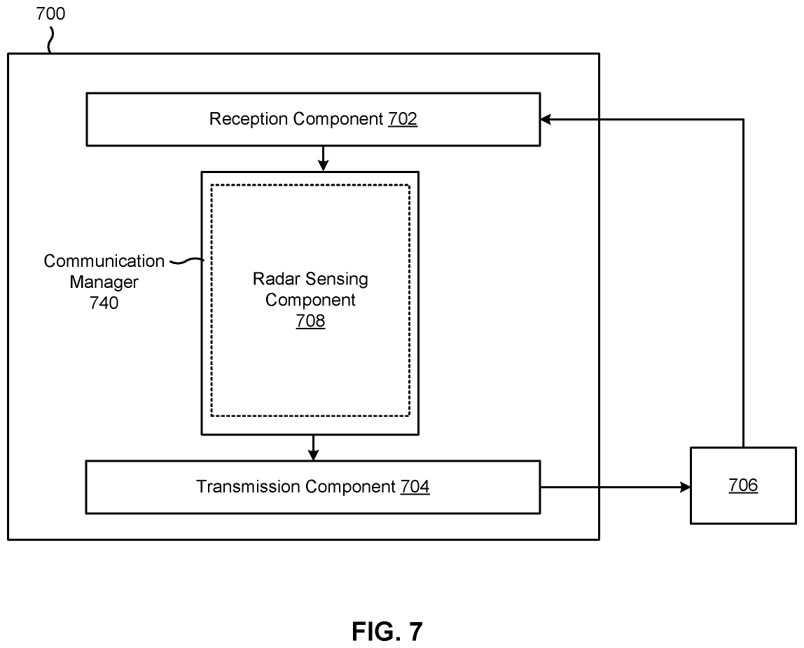

As shown in FIG. 6, in some aspects, process 600 may include transmitting a set of radar reference signals using a set of resource elements, wherein the set of radar reference signals are associated with a phase rotation corresponding to a phase ramp (block 610). For example, the network node (e.g., using communication manager 740 and/or transmission component 704, depicted in FIG. 7) may transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp, as described above.

As further shown in FIG. 6, in some aspects, process 600 may include receiving a response for the set of radar reference signals (block 620). For example, the network node (e.g., using communication manager 740 and/or reception component 702, depicted in FIG. 7) may receive a response for the set of radar reference signals, as described above.

Process 600 may include additional aspects, such as any single aspect or any combination of aspects described below and/or in connection with one or more other processes described elsewhere herein.

In a first aspect, the response includes a radar return associated with the set of radar reference signals.

In a second aspect, alone or in combination with the first aspect, process 600 includes detecting one or more targets using the response for the set of radar reference signals.

In a third aspect, alone or in combination with one or more of the first and second aspects, transmitting the set of radar reference signals comprises transmitting the set of radar reference signals when radar sensing is disabled for the network node.

In a fourth aspect, alone or in combination with one or more of the first through third aspects, transmitting the set of radar reference signals comprises transmitting the set of radar reference signals when radar sensing is enabled for the network node.

In a fifth aspect, alone or in combination with one or more of the first through fourth aspects, the set of radar reference signals is associated with a radar reference signal resource element pattern within each set of symbols, of the set of symbols, and wherein the radar reference signal resource element pattern is common to a plurality of network nodes.

In a sixth aspect, alone or in combination with one or more of the first through fifth aspects, the radar reference signal resource element pattern is associated with a comb-type pattern.

In a seventh aspect, alone or in combination with one or more of the first through sixth aspects, the radar reference signal resource element pattern spans one or more orthogonal frequency division multiplexing symbols and repeats to cover each orthogonal frequency division multiplexing symbol of the set of radar reference signals.

In an eighth aspect, alone or in combination with one or more of the first through seventh aspects, a radar reference signal symbol value for a radar reference signal resource element, of the set of radar reference signals, in a particular symbol of the sets of symbols, is based at least in part on a base symbol sequence common to a plurality of network nodes and a phase rotation associated with each radar reference signal resource element within the particular symbol.

In a ninth aspect, alone or in combination with one or more of the first through eighth aspects, process 600 includes transmitting a set of data resource elements within the symbol, wherein the set of data resource elements are not phase rotated in accordance with the phase rotation for the particular symbol.

In a tenth aspect, alone or in combination with one or more of the first through ninth aspects, the base symbol sequence is based at least in part on a Gold sequence mapped to a set of quadrature phase shift keying symbols.

In an eleventh aspect, alone or in combination with one or more of the first through tenth aspects, the base symbol sequence is associated with a duration of one or more orthogonal frequency division multiplexing symbols.

In a twelfth aspect, alone or in combination with one or more of the first through eleventh aspects, the base symbol sequence is repeated across a plurality of radar reference signals in the set of radar reference signals based at least in part on a quantity of orthogonal frequency division multiplexing symbols of the set of radar reference signals.

In a thirteenth aspect, alone or in combination with one or more of the first through twelfth aspects, process 600 includes sensing one or more targets within a proximity of the network node based at least in part on the response for the set of radar resource elements.

In a fourteenth aspect, alone or in combination with one or more of the first through thirteenth aspects, sensing the one or more targets comprises sensing the one or more targets based at least in part on one or more data symbols, wherein the one or more data symbols are subject to an interference cancellation procedure.

In a fifteenth aspect, alone or in combination with one or more of the first through fourteenth aspects, process 600 includes determining the phase ramp based at least in part on at least one of a random selection procedure, a pseudo-random selection procedure, a configured pattern, or a codebook of configured patterns.

In a sixteenth aspect, alone or in combination with one or more of the first through fifteenth aspects, the phase ramp is associated with a first one or more values and another phase ramp associated with another network node is associated with a second one or more values.

In a seventeenth aspect, alone or in combination with one or more of the first through sixteenth aspects, filtering the first one or more targets and the second one or more targets comprises filtering the first one or more targets and the second one or more targets based at least in part on a coherent processing interval and a set of detected velocities or a set of energy peaks of the set of targets.

In an eighteenth aspect, alone or in combination with one or more of the first through seventeenth aspects, process 600 includes determining a phase ramp duration for the phase ramp based at least in part on at least one of a coherent processing interval, a network node specific configuration, a range of permissible phase ramp durations, or a static configuration common to a plurality of network nodes.

In a nineteenth aspect, alone or in combination with one or more of the first through eighteenth aspects, the coherent processing interval is common to a plurality of network nodes.

In a twentieth aspect, alone or in combination with one or more of the first through nineteenth aspects, process 600 includes transmitting an indication of the phase ramp, wherein channel estimation is based at least in part on the phase ramp.

In a twenty-first aspect, alone or in combination with one or more of the first through twentieth aspects, the indication of the phase ramp includes an index value identifying a codebook entry corresponding to the phase ramp.

In a twenty-second aspect, alone or in combination with one or more of the first through twenty-first aspects, the indication of the phase ramp is conveyed in at least one of uplink control information, downlink control information, or sidelink control information.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a network node, or a network node may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 740. The communication manager 740 (e.g., the communication manager 140 or the communication manager 396) may include a radar sensing component 708, among other examples.

In some aspects, the apparatus 700 may be configured to perform one or more operations described herein in connection with FIGS. 5A-5C. Additionally, or alternatively, the apparatus 700 may be configured to perform one or more processes described herein, such as process 600 of FIG. 6. In some aspects, the apparatus 700 and/or one or more components shown in FIG. 7 may include one or more components of the network node described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the network node described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the network node described in connection with FIG. 2. In some aspects, the transmission component 704 may be co-located with the reception component 702 in a transceiver.

The transmission component 704 may transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp. The reception component 702 may receive a response for the set of radar reference signals.

The radar sensing component 708 may detect one or more targets using the response for the set of radar reference signals. The transmission component 704 may transmit a set of data resource elements within the symbol, wherein the set of data resource elements are not phase rotated in accordance with the phase rotation for the particular symbol. The radar sensing component 708 may sense one or more targets within a proximity of the network node based at least in part on the response for the set of radar resource elements. The radar sensing component 708 may determine the phase ramp based at least in part on at least one of a random selection procedure, a pseudo-random selection procedure, a configured pattern, or a codebook of configured patterns. The radar sensing component 708 may determine a phase ramp duration for the phase ramp based at least in part on at least one of a coherent processing interval, a network node specific configuration, a range of permissible phase ramp durations, or a static configuration common to a plurality of network nodes. The transmission component 704 may transmit an indication of the phase ramp, wherein channel estimation is based at least in part on the phase ramp.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a network node, comprising: transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and receiving a response for the set of radar reference signals.

Aspect 2: The method of Aspect 1, wherein the response includes a radar return associated with the set of radar reference signals.

Aspect 3: The method of any of Aspects 1 to 2, further comprising: detecting one or more targets using the response for the set of radar reference signals.

Aspect 4: The method of any of Aspects 1 to 3, wherein transmitting the set of radar reference signals comprises: transmitting the set of radar reference signals when radar sensing is disabled for the network node.

Aspect 5: The method of any of Aspects 1 to 3, wherein transmitting the set of radar reference signals comprises: transmitting the set of radar reference signals when radar sensing is enabled for the network node.

Aspect 6: The method of any of Aspects 1 to 4, wherein the set of radar reference signals is associated with a radar reference signal resource element pattern within each set of symbols, of the set of symbols, and wherein the radar reference signal resource element pattern is common to a plurality of network nodes.

Aspect 7: The method of Aspect 6, wherein the radar reference signal resource element pattern is associated with a comb-type pattern.

Aspect 8: The method of any of Aspects 6 to 7, wherein the radar reference signal resource element pattern spans one or more orthogonal frequency division multiplexing symbols and repeats to cover each orthogonal frequency division multiplexing symbol of the set of radar reference signals.

Aspect 9: The method of any of Aspects 1 to 8, wherein a radar reference signal symbol value for a radar reference signal resource element, of the set of radar reference signals, in a particular symbol of the sets of symbols, is based at least in part on a base symbol sequence common to a plurality of network nodes and a phase rotation associated with each radar reference signal resource element within the particular symbol.

Aspect 10: The method of Aspect 9, further comprising: transmitting a set of data resource elements within the symbol, wherein the set of data resource elements are not phase rotated in accordance with the phase rotation for the particular symbol.

Aspect 11: The method of any of Aspects 9 to 10, wherein the base symbol sequence is based at least in part on a Gold sequence mapped to a set of quadrature phase shift keying symbols.

Aspect 12: The method of any of Aspects 9 to 11, wherein the base symbol sequence is associated with a duration of one or more orthogonal frequency division multiplexing symbols.

Aspect 13: The method of any of Aspects 9 to 12, wherein the base symbol sequence is repeated across a plurality of radar reference signals in the set of radar reference signals based at least in part on a quantity of orthogonal frequency division multiplexing symbols of the set of radar reference signals.

Aspect 14: The method of any of Aspects 1 to 13, further comprising: sensing one or more targets within a proximity of the network node based at least in part on the response for the set of radar resource elements.

Aspect 15: The method of Aspect 14, wherein sensing the one or more targets comprises: sensing the one or more targets based at least in part on one or more data symbols, wherein the one or more data symbols are subject to an interference cancellation procedure.

Aspect 16: The method of any of Aspects 1 to 15, further comprising: determining the phase ramp based at least in part on at least one of: a random selection procedure, a pseudo-random selection procedure, a configured pattern, or a codebook of configured patterns.

Aspect 17: The method of any of Aspects 1 to 16, wherein the phase ramp is associated with a first one or more values and another phase ramp associated with another network node is associated with a second one or more values.

Aspect 18: The method of Aspect 17, wherein filtering the first one or more targets and the second one or more targets comprises: filtering the first one or more targets and the second one or more targets based at least in part on a coherent processing interval and a set of detected velocities or a set of energy peaks of the set of targets.

Aspect 19: The method of any of Aspects 1 to 18, further comprising: determining a phase ramp duration for the phase ramp based at least in part on at least one of: a coherent processing interval, a network node specific configuration, a range of permissible phase ramp durations, or a static configuration common to a plurality of network nodes.

Aspect 20: The method of Aspect 19, wherein the coherent processing interval is common to a plurality of network nodes.

Aspect 21: The method of any of Aspects 1 to 20, further comprising: transmitting an indication of the phase ramp, wherein channel estimation is based at least in part on the phase ramp.

Aspect 22: The method of Aspect 21, wherein the indication of the phase ramp includes an index value identifying a codebook entry corresponding to the phase ramp.

Aspect 23: The method of any of Aspects 21 to 22, wherein the indication of the phase ramp is conveyed in at least one of: uplink control information, downlink control information, or sidelink control information.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and
receive a response for the set of radar reference signals.

2. The network node of claim 1, wherein the response includes a radar return associated with the set of radar reference signals.

3. The network node of claim 1, wherein the one or more processors are further configured to:
detect one or more targets using the response for the set of radar reference signals.

4. The network node of claim 1, wherein the one or more processors, to transmit the set of radar reference signals, are configured to:
transmit the set of radar reference signals when radar sensing is disabled for the network node.

5. The network node of claim 1, wherein the one or more processors, to transmit the set of radar reference signals, are configured to:
transmit the set of radar reference signals when radar sensing is enabled for the network node.

6. The network node of claim 1, wherein the set of radar reference signals is associated with a radar reference signal resource element pattern within each set of symbols, of the set of symbols, and
wherein the radar reference signal resource element pattern is common to a plurality of network nodes.

7. The network node of claim 6, wherein the radar reference signal resource element pattern is associated with a comb-type pattern.

8. The network node of claim 6, wherein the radar reference signal resource element pattern spans one or more orthogonal frequency division multiplexing symbols and repeats to cover each orthogonal frequency division multiplexing symbol of the set of radar reference signals.

9. The network node of claim 1, wherein a radar reference signal symbol value for a radar reference signal resource element, of the set of radar reference signals, in a particular symbol of the sets of symbols, is based at least in part on a base symbol sequence common to a plurality of network nodes and a phase rotation associated with each radar reference signal resource element within the particular symbol.

10. The network node of claim 9, wherein the one or more processors are further configured to:
transmit a set of data resource elements within the particular symbol, wherein the set of data resource elements are not phase rotated in accordance with the phase rotation for the particular symbol.

11. The network node of claim 9, wherein the base symbol sequence is based at least in part on a Gold sequence mapped to a set of quadrature phase shift keying symbols.

12. The network node of claim 9, wherein the base symbol sequence is associated with a duration of one or more orthogonal frequency division multiplexing symbols.

13. The network node of claim 9, wherein the base symbol sequence is repeated across a plurality of radar reference signals in the set of radar reference signals based at least in part on a quantity of orthogonal frequency division multiplexing symbols of the set of radar reference signals.

14. The network node of claim 1, wherein the one or more processors are further configured to:
sense one or more targets within a proximity of the network node based at least in part on the response for the set of radar resource elements.

15. The network node of claim 14, wherein the one or more processors, to sense the one or more targets, are configured to:
sense the one or more targets based at least in part on one or more data symbols, wherein the one or more data symbols are subject to an interference cancellation procedure.

16. The network node of claim 1, wherein the one or more processors are further configured to:
determine the phase ramp based at least in part on at least one of:
a random selection procedure,
a pseudo-random selection procedure,
a configured pattern, or
a codebook of configured patterns.

17. The network node of claim 1, wherein the phase ramp is associated with a first one or more values and another phase ramp associated with another network node is associated with a second one or more values.

18. The network node of claim 1, wherein the one or more processors are further configured to:
determine a phase ramp duration for the phase ramp based at least in part on at least one of:
a coherent processing interval,
a network node specific configuration,
a range of permissible phase ramp durations, or
a static configuration common to a plurality of network nodes.

19. The network node of claim 18, wherein the coherent processing interval is common to a plurality of network nodes.

20. The network node of claim 1, wherein the one or more processors are further configured to:
transmit an indication of the phase ramp, wherein channel estimation is based at least in part on the phase ramp.

21. The network node of claim 20, wherein the indication of the phase ramp includes an index value identifying a codebook entry corresponding to the phase ramp.

22. The network node of claim 20, wherein the indication of the phase ramp is conveyed in at least one of: uplink control information, downlink control information, or sidelink control information.

23. A method of wireless communication performed by a network node, comprising:
transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and
receiving a response for the set of radar reference signals.

24. The method of claim 23, wherein the response includes a radar return associated with the set of radar reference signals.

25. The method of claim 23, further comprising:
detecting one or more targets using the response for the set of radar reference signals.

26. The method of claim 23, wherein transmitting the set of radar reference signals comprises:
transmitting the set of radar reference signals when radar sensing is disabled for the network node.

27. The method of claim 23, wherein transmitting the set of radar reference signals comprises:
transmitting the set of radar reference signals when radar sensing is enabled for the network node.

28. The method of claim 23, wherein the set of radar reference signals is associated with a radar reference signal resource element pattern within each set of symbols, of the set of symbols, and
wherein the radar reference signal resource element pattern is common to a plurality of network nodes.

29. A non-transitory computer-readable medium storing a set of instructions for wireless communication, the set of instructions comprising:
one or more instructions that, when executed by one or more processors of a network node, cause the network node to:
transmit a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and
receive a response for the set of radar reference signals.

30. An apparatus for wireless communication, comprising:
means for transmitting a set of radar reference signals using a set of resource elements, wherein the set of radar reference signals are associated with a phase rotation corresponding to a phase ramp, wherein the phase ramp has a set of values for sets of symbols such that a first set of symbols, of the sets of symbols, is associated with a first value, of the set of values, for the phase ramp and a second set of symbols, of the sets of symbols, is associated with a second value, of the set of values, for the phase ramp; and
means for receiving a response for the set of radar reference signals.
